(19) United States
(12) Patent Application Publication
(10) Pub. No.: US 2015/0360990 A1
(43) Pub. Date: Dec. 17, 2015

(54) METHOD AND DEVICE FOR PRODUCING A GLASS ARTICLE FROM A GLASS MELT

(71) Applicant: SCHOTT AG, Mainz (DE)

(72) Inventors: Frank-Thomas Lentes, Bingen (DE); Karin Naumann, Ober-Olm (DE); Monika Buerkner-Brigaldino, Ginsheim-Gustavsberg (DE); Norbert Greulich-Hickmann, Mainz (DE); Jan Philipp Steigleder, Mainz (DE)

(21) Appl. No.: 14/739,780

(22) Filed: Jun. 15, 2015

(30) Foreign Application Priority Data
Jun. 13, 2014 (DE) 10 2014 211 346.6

(51) Int. Cl. C03B 5/187; B01F 7/00

(52) U.S. Cl. CPC C03B 5/187; B01F 7/00125; B01F 7/0025

(57) ABSTRACT

Methods for producing glass articles from glass melts are provided that include continuously introducing the glass melt into a stirrer vessel, stirring the glass melt in the stirrer vessel by at least one blade stirrer, continuously discharging the glass melt from the stirrer vessel, and shaping the glass melt to obtain the glass article. In some embodiments, the stirring is sufficient to draw the glass melt located at a surface of the stirrer vessel into the stirrer vessel so that a formation of a surface layer of the glass melt with a different composition from the composition of the glass melt introduced is prevented or at least minimized. In other embodiments, the stirring is sufficient so that the glass melt which is located at a surface in the stirrer vessel is not drawn into the stirrer vessel or is drawn in only insubstantially.

### CROSS REFERENCE TO RELATED APPLICATIONS

This application claims benefit under 35 U.S.C. §119(a) of German Patent Application No. 10 2014 211 346.6 filed Jun. 13, 2014, the entire contents of which are incorporated herein by reference.

### BACKGROUND OF THE INVENTION

1. Field of the Invention

The invention relates to a method for producing a glass article from a glass melt. Furthermore, the invention relates to a device for producing a glass article from a glass melt.

2. Description of Related Art

Such methods and devices are known in principle, e.g. from the documents DE102006060972 A1 and DE102007035203 A1.

The stirring devices used here with blade stirrer arranged in the device are as a rule designed in such a way that the following conditions are satisfied:

High homogeneity index

$$H = N \cdot v \cdot \frac{ρ {nLD}^{2}}{\dot{m}} > 6000 ,$$

where
N: number of stirring devices connected after one another

ν: stirrer rotational speed

ρ: density of the glass

n: number of stirrer blades

L: internal length of the stirring device

D: internal diameter of the stirring device, and

\dot{m}: mass flow.

Minimization of the wall shear stress

$$τ = η \cdot \frac{π D}{w} \cdot v < 500 Pa$$

on the inner wall of the stirring device, e.g. made of highly zirconium-containing, ceramic refractory material, where

η: viscosity of the glass

D: internal diameter of the stirring device;

w: wall spacing (stirrer blade/inner wall)

ν: rotational speed.

These conditions are generally reached by means of: large stirred volume, i.e. large internal diameter D and large internal overall height L, moderate rotational speeds of the stirrer (3 to 10 rev/min), in conjunction with an axially conveying stirring device with pitched stirrer blades, with a comparatively long residence time of the glass melt in the stirring device, by means of high expansion, intense re-orientation and separation of streaks (inhomogeneities) found in the glass melt, a very high level of homogenization of the glass melt can be achieved.

It has transpired that the known methods and devices have the following disadvantages.

First, a comparatively large free surface of the glass melt in the stirring device

$$A = \frac{π}{4} {D}^{2} ,$$

which—particularly in conjunction with a burner-heated top oven of the stirring device—leads to a chemically changed surface layer (e.g. as a result of evaporation from highly volatile components of the glass melt, “evaporation layer”). Because of the loss of constituents of the glass melt, this evaporation layer is generally more viscous at application temperature (temperature of the glass melt in the stirrer vessel) than the remaining glass melt and, at application temperature, generally also has a slightly higher density than the remaining glass melt.

In any case, however, viscosity and density of glass melt and “evaporation layer” differ. (When determining viscosity and density, the temperature dependence has to be taken into account, so that, at room temperature, it is also possible for a reversal of the above-described relationships to occur at application temperature).

Second, known methods and devices are not capable of re-dissolving and stirring (homogenizing) these more viscous glass melt components for very high requirements on the homogeneity of the glass melt.

Third, the uppermost rotating stirrer blade, which is located under the glass surface, causes a bow wave which, on the inner wall of the stirring device, leads to slopping movements of the glass melt; this is highly probably associated with the formation and the incorporation of undesired gases bubbles into the glass melt.

The devices used for the production of glass, comprising a stirring device with blade stirrer arranged in the stirring device, are used to improve the large-scale volume homogeneity and small-scale homogeneity (freedom from streaks) of the glass melt. To this end, as compared with small-dimension stirring devices (with smaller free surfaces), they have a substantially longer residence time of the glass melt in the stirring device. The free surface is exposed for longer to the atmosphere, which can lead to evaporation and other chemical reactions and, as a result, to impairment of the homogeneity of the glass melt and ultimately of the resultant display glass.

Surface glass melt is produced by evaporation of specific components at the temperature at which it is stirred. A water-containing furnace atmosphere promotes the evaporation. The enrichment of highly volatile components from the surface generally leads to a more viscous glass melt at the surface at application temperature. At application temperature, these viscosity differences can no longer be compensated for by diffusion processes in the glass melt.

The slopping of the glass melt—induced by the bow wave of the rotating stirrer blade—on the inner wall of the stirring device is a dangerous source for new bubbles in the glass melt, which must be minimized without fail for the high optical requirements of special glass.

With increasing volume of the stirrer vessel, the surface of the glass melt in the stirrer vessel generally also increases. In particular in the event of additional heating of the surface of the glass melt in the stirrer vessel, e.g. by means of burners, this can lead to an undesired change in the composition of the glass melt at the surface in the stirrer vessel. More highly volatile composition components of the glass melt, such as Li, Na, K, B, P, F, CI, are depleted.

During the heating of the glass melt in the stirrer vessel by means of burners, combustion gases which arise, in particular H₂O, can be incorporated in the glass melt and thus enriched. These both lead to an undesired change in the composition of the glass melt in the stirrer vessel, to changes with respect to viscosity and density, to inhomogeneities which, in the subsequent process steps, can no longer be eliminated or only with considerable effort, and ultimately to defects (such as excessively disruptive streaks or bubbles) in the glass article to be produced, which in turn can lead to considerable economic losses, in particular if the optical properties of the glass article matter.

### SUMMARY

The object of the invention is to find an improved method and an improved device for the economical production of a glass article from a glass melt.

According to the invention, two methods for achieving this object, which both lead to comparatively good results, are proposed.

One method for producing a glass article from a glass melt according to the invention (i.e., method 1) includes at least the following steps: continuous introduction of the glass melt into a stirrer vessel, stirring the glass melt in the stirrer vessel by means of at least one blade stirrer, the blade stirrer having at least one stirrer blade, which is fixed to a stirrer shaft arranged substantially vertically in the stirrer vessel, continuous discharge of the glass melt from the stirrer vessel, shaping the glass melt, obtaining the glass article, characterized in that as a result of the stirring, the glass melt which is located at the surface in the stirrer vessel is drawn into the stirrer vessel, so that the formation of a surface layer of the glass melt with a different composition from the composition of the glass melt introduced is prevented or at least minimized.

The fact that the glass melt which is located at the surface in the stirrer vessel is drawn continuously into the stirrer vessel (in particular towards the stirrer shaft) means that even minimal changes of the composition of the glass melt at the surface thereof are compensated for. The albeit only slightly changed surface glass melt is mixed with the remaining glass melt in good time, so that for the first time even small disruptive inhomogeneities cannot form. It depends substantially on the requirements on the glass article to be produced as to how intensely the glass melt which is located at the surface in the stirrer vessel has to be drawn into the stirrer vessel, in particular towards the stirrer shaft, by the stirring, so that the formation of a surface layer of the glass melt with a different composition from the composition of the glass melt introduced is prevented (very high requirements on the optical properties of the glass article) or at least minimized (at least such that the glass article to be produced in particular satisfies the optical specifications).

Preferably, the uppermost stirrer blade in method 1 is configured in such a way and is arranged at a distance A1 from the surface of the glass melt in the stirrer vessel such that the drawing-in action is substantially effected as a result.

Another method for producing a glass article from a glass melt according to the invention (i.e., method 2) includes at least the following steps: continuous introduction of the glass melt into a stirrer vessel, stirring the glass melt in the stirrer vessel by means of at least one blade stirrer, the blade stirrer having at least one stirrer blade, which is fixed to a stirrer shaft arranged substantially vertically in the stirrer vessel, continuous discharge of the glass melt from the stirrer vessel, shaping the glass melt, obtaining the glass article, characterized in that as a result of the stirring, the glass melt which is located at the surface in the stirrer vessel is not drawn into the stirrer vessel or is drawn in only insubstantially.

The fact that the glass melt which is located at the surface in the stirrer vessel is not drawn into the stirrer vessel or is drawn in only insubstantially means that a protective layer (with a different composition from the composition of the glass melt introduced) can form at the surface of the glass melt in the stirrer vessel, which effectively prevents a further change in the composition of the glass melt in the stirrer vessel, so that no more disruptive inhomogeneities can form underneath the protective layer. It depends substantially on the glass article to be produced as to how the glass melt which is located at the surface in the stirrer vessel is not drawn into the stirrer vessel (very high requirements on the optical properties of the glass article) or is drawn in only insubtantially (at least such that the glass article to be produced in particular satisfies the optical specifications) by the stirring.

Preferably, the uppermost stirrer blade in method 2 is configured in such a way and is arranged at a distance A2 from the surface of the glass melt in the stirrer vessel such that the glass melt which is located at the surface in the stirrer vessel is substantially not drawn into the stirrer vessel or is drawn in only insubstantially as a result.

In the following text, preferred design variants of the above methods according to the invention will be described.

The blade stirrer preferably has a plurality of stirrer blades, the uppermost stirrer blade generating a downward flow of the glass melt along the stirrer shaft, and the lowest stirrer blade generating an upward flow of the glass melt along the stirrer shaft.

Preferably, the blade stirrer has a plurality of stirrer blades, a smaller spacing being set between adjacent stirrer blades which generate a unidirectional flow of the glass melt along the stirrer shaft than between adjacent stirrer blades which generate an opposed flow of the glass melt along the stirrer shaft.

The continuous introduction of the glass melt can be carried out in an upper region of the stirrer vessel and the continuous discharge in a lower region of the stirrer vessel or vice versa.

The viscosity of the glass melt is between 100 and 300 Pas.

A plurality of stirrer vessels can be arranged in series.

As a result of the stirring, the glass melt which is located at the surface in the stirrer vessel can effect a maximum amplitude of the up-and-down movement of the glass melt at the surface of at most 2%, preferably at most 1%, of the glass melt level in the stirrer vessel at a stirrer rotational speed of 6 rev/min.

The stirrer rotational speed can be set in the range from 0.5 to 20 rev/min, preferably 1 to 15 rev/min and particularly preferably 2 to 10 rev/min.

The shaping of the glass melt can comprise floating, drawing or rolling of the glass melt.

Furthermore, the object of the invention is achieved by one of the two devices (device 1 and device 2) having the following features (method 1 is carried out by device 1, method 2 by device 2):

One device for producing a glass article from a glass melt according to the present invention (i.e. device 1) includes: means for the continuous introduction of the glass melt into a stirrer vessel, means for stirring the glass melt in the stirrer vessel by means of at least one blade stirrer, the blade stirrer having at least one stirrer blade which is fixed to a stirrer shaft arranged substantially vertically in the stirrer vessel, means for the continuous discharge of the glass melt from the stirrer vessel, means for shaping the glass melt, obtaining the glass article, characterized in that the means for stirring the glass melt are configured and arranged in such a way that the glass melt which is located at the surface in the stirrer vessel can be drawn into the stirrer vessel (in particular along the stirrer shaft), so that the formation of a surface layer of the glass melt with a different composition from the composition of the glass melt introduced can be prevented or at least minimized.

Preferably, the uppermost stirrer blade in device 1 is configured in such a way and is arranged at a distance A1 from the surface of the glass melt in the stirrer vessel such that the drawing-in action is substantially effected as a result.

Preferred geometry of device 1: five stirrer blades with rhombic geometry, stirring circle diameter of the uppermost blade (9) is <50%, preferably <45% of the maximum stirring circle diameter, stirrer blades (6, 7) have the maximum stirring circle diameter stirring circle diameter of stirrer blades (5, 8) is <95%, preferably <90% of the maximum stirring circle diameter, blade spacing of the uppermost three blades (7, 8, 9) is at least the height of the rhombus, upper three stirrer blades (7, 8, 9) in the case of anticlockwise stirrers, viewed from above, are arranged to be offset azimuthally downwards by 10° in the anticlockwise direction and convey downwards, assisted by the rhombic geometry, the angle of attack of the rhombus being 35°, in the lower two stirrer blades (5, 6), stirrer blade (6) is not arranged to be offset azimuthally with respect to stirrer blade 7, and stirrer blade (5) in the case of anticlockwise stirrers, viewed from above, is arranged to be offset azimuthally by 10° in the clockwise direction with respect to stirrer blade (6). Both stirrer blades (5, 6) convey upwards, assisted by the rhombic geometry, the angle of attack of the rhombus being 145°, blade spacing of the lowest two blades (5, 6) is at least the height of the rhombus, blade spacing between the stirrer blades conveying downwards (7,8,9) and upwards (5, 6) is 50% greater than the blade spacing of the stirrer blades conveying unidirectionally, uppermost blades 180 mm below the glass melt surface (A1), viscosity of the glass melt 140 Pa·s.

Another device for producing a glass article from a glass melt according to the present invention (i.e., device 2) includes: means for the continuous introduction of the glass melt into a stirrer vessel, means for stirring the glass melt in the stirrer vessel by means of at least one blade stirrer, the blade stirrer having at least one stirrer blade which is fixed to a stirrer shaft arranged substantially vertically in the stirrer vessel, means for the continuous discharge of the glass melt from the stirrer vessel, means for shaping the glass melt, obtaining the glass article, characterized in that the means for stirring the glass melt are configured and arranged in such a way that the glass melt which is located at the surface in the stirrer vessel cannot be drawn into the stirrer vessel or is drawn in only insubstantially.

Preferably, the uppermost stirrer blade in device 2 is configured in such a way and is arranged at a distance A2 from the surface of the glass melt in the stirrer vessel such that the glass melt which is located at the surface in the stirrer vessel is substantially not drawn into the stirrer vessel or is drawn in only insubstantially as a result.

Preferably, the respective stirrer blades (methods 1 and 2, device 1 and 2) comprise two part blades, which have a common collinear axis of symmetry, which passes through at right angles to the stirrer shaft. The stirrer blade comprising two part blades has a defined blade diameter and describes a stirring circle diameter in the stirrer vessel. The two parts of the stirrer blade have a geometry which assists the conveying action, for example a rhombic geometry, the preferred ratio of the lengths of the diagonals being 1:1 to 1:2.

Preferred geometry of device 2: four stirrer blades with rhombic geometry stirrer blades (6, 7) have the maximum stirring circle diameter, stirring circle diameter of stirrer blades (5, 8) is <95%, preferably <90% of the maximum stirring circle diameter, blade spacing of the uppermost two blades (7, 8) is at least the height of the rhombus, upper two stirrer blades (7, 8) in the case of anticlockwise stirrers, viewed from above, are arranged in each case to be offset azimuthally downwards by 10° in the anticlockwise direction and convey downwards, assisted by the rhombic geometry, the angle of attack of the rhombus being 35°, in the lower two stirrer blades (5, 6), stirrer blade (6) is not arranged to be offset azimuthally with respect to stirrer blade 7, and stirrer blade (5) in the case of anticlockwise stirrers, viewed from above, is arranged to be offset azimuthally by 10° in the clockwise direction with respect to stirrer blade (6). Both stirrer blades (5, 6) convey upwards, assisted by the rhombic geometry, the angle of attack of the rhombus being 145°, blade spacing of the lowest two blades (5, 6) is at least the height of the rhombus, blade spacing between the stirrer blades conveying downwards (7,8,9) and upwards (5, 6) is 50% greater than the blade spacing of the stirrer blades conveying unidirectionally, uppermost blades 310 mm below the glass melt surface (A2), viscosity of the glass melt: 160 Pa·s

Further design variants of the invention which relate in a practical way to the methods 1 and 2 and to the devices 1 and 2 will be described below.

The stirring of the glass melt can be carried out by means of at least one blade stirrer arranged in the stirrer vessel, the blades of which have a geometry and arrangement influencing the movement and flow of the glass melt in the stirrer vessel so that, by means of the stirring, the glass melt which is located at the surface in the stirrer vessel has a passage time through the stirrer vessel which is higher at most by the factor 10, preferably at most by the factor 5, than the remaining glass melt led through the stirrer vessel, or has a passage time through the stirrer vessel which is higher at least by the factor 1000, preferably at least by the factor 2000, than the remaining glass melt led through the stirrer vessel.

The inventors have recognized that, according to measure a), the glass melt which is located at the surface of the stirrer vessel is mixed continuously with the remaining glass melt in the stirrer vessel and thus the inhomogeneities forming at the surface of the glass melt are continuously dissolved and mixed as well as possible before their manifestation becomes too great to have a detrimental influence on the quality of the resultant glass article.

Furthermore, the inventors have recognized that, according to measure b), the glass melt which is located at the surface of the stirrer vessel is left at rest as far as possible, so that the inhomogeneities forming at the surface are mixed as little as possible with the remaining glass melt and thus can have a less detrimental influence on the quality of the resultant glass article.

As a result of the stirring, the glass melt which is located at the surface in the stirrer vessel preferably has a maximum amplitude of the up-and-down movement of the glass melt at the surface (slopping) of at most 20 mm, preferably of at most 10 mm and particularly preferably of at most 5 mm. Thus, the introduction of gas bubbles at the surface of the glass melt can be reduced effectively (reduction in the slopping movement).

Preferably, a wall shear stress of less than 500 Pa, in particular of less than 400 Pa is established in the stirrer vessel.

Preferably, up to 100 tonnes of glass melt per day can be led through the stirrer vessel.

The passage time can be determined, for example, by means of a tracer test, a tracer being put into the glass melt as the glass melt is introduced into the stirrer vessel, at the same time another tracer being put onto the surface of the glass melt in the stirrer vessel, and the passage time of the two tracers being determined at a point following the discharge.

According to the invention, a flat glass, for example a display glass or covering glass for electronic devices such as smart phones, tablet computers or monitors with a maximum amplitude of the strip-like vertical fluctuations of the glass surface, designated waviness (r.m.s. value of the surface profile for structure widths between 0.8 mm and 8 mm; cf. SEMI D24-2000: Specification for glass substrates used to manufacture flat panel displays 2006), of less than 200 nm, preferably of less than 100 nm, further preferably of less than 70 nm, can be produced.

The blades of the blade stirrer can have a geometry and arrangement such that, during the stirring of the glass melt, the movement and flow of the latter in the stirrer vessel is influenced in such a way that, as a result of the stirring, the glass melt which is located at the surface in the stirrer vessel has a passage time through the stirrer vessel which is higher at most by the factor 10, preferably at most by the factor 5, than the remaining glass melt led through the stirrer vessel, or has a passage time through the stirrer vessel which is higher at least by the factor 1000, preferably at least by the factor 2000, than the remaining glass melt led through the stirrer vessel.

The stirrer vessel can preferably consist of refractory material, in particular of highly zirconium-containing refractory material, or be lined therewith.

The blade stirrer can have at least one of the following features, in order in particular to influence the passage time: first stirrer blade from the top has a smaller blade diameter than the adjacent stirrer blade, spacing of stirrer blades from one another on the stirrer shaft being equal to one another or different, angle of attack of stirrer blade being equal to or different from adjacent stirrer blade, conveying action of the stirrer blades upwards or downwards, stirrer blade rotates with respect to adjacent blade or does not rotate, distance of the first stirrer blade from the top to the surface of the glass melt, distance of the first blade from the bottom to the bottom of the stirring device, number of blades even or odd.

The two disadvantages of the known devices and methods, inadequate homogenization of the glass melt close to the surface and stirrer-induced slopping of the glass melt surface on the inner wall, are to be eliminated, the other advantages of the stirrer being maintained.

The devices can have or effect the following: high viscosity constancy (large-scale and small-scale, i.e. on physical scales of a few mm or cm); suitable for float processes; waviness of the glass article surface of less than 200 nm, preferably of less than 100 nm, further preferably of less than 70 nm, without subsequent polishing (surface processing), only what is known as touch polishing suitable for glass thicknesses <1 mm.

Evaporation at the glass melt surface in the stirrer vessel leads to no impairment of the stirrer result and the slopping of the glass melt at the interface to the stirrer vessel is suppressed (avoiding the risk of new bubble formation).

By means of the methods according to the invention and the devices according to the invention, it is now in particular possible to produce thin glass with very low waviness and high evenness.

At the same time, whilst maintaining previously tried and tested properties, the stirring concept has been modified such that chemically changed surface glass melts of high viscosity are prevented from getting into the already stirred and homogenized glass melt and being able to cause drawing streaks and/or waviness problems. The thinner the glass articles to be produced become, the higher the requirements on the homogeneity become. Extremely small inhomogeneities in composition and/or viscosity on the surface are reflected in an uncontrolled manner in the glass article and cause irregularities, drawing streaks, waviness problems or other surface effects, which make subsequent and complicated surface processing or polishing of the glass article necessary. It is therefore no longer sufficient merely to make the glass melt volume streak-free; instead the glass melt at the surface in the stirrer vessel must specifically be taken into account in the homogenization process.

Although the volume homogenization can be improved considerably by means of larger stirrer vessels, as a result of larger stirrer vessels, the free surface of the glass melt in the stirrer vessel also increases and therefore so does the susceptibility to surface-induced drawing streaks or waviness problems in the resultant glass article.

The methods according to the invention and the devices according to the invention are suitable to meet very high demands on the glass quality with respect to homogeneity and freedom from streaks and, furthermore, are capable of stirring the glass melt in continuously at the stirrer vessel surface according to method 1/device 1 and feature a), so that the glass melt surface is continuously replaced and the formation of a chemically changed glass melt surface is suppressed.

Alternatively, method and device are embodied in such a way that the glass surface in the stirrer vessel is substantially not touched during the stirring—apart from, for example, the stirrer shaft of the blade stirrer—so that a stable “skin” forms on the glass surface, preventing further depletion of glass components that are susceptible to evaporation (vessel 2/device 2 and feature b).

Surprisingly it has been found that, by means of both variants method 1/device 1 and feature a) or method 2/device 2 and feature b), the evenness/waviness of a thin glass that is produced can be improved. The “slopping” of the glass melt level caused by the upper stirrer blade at the inner wall of the stirrer vessel can above all be reduced highly by means of the geometry of the upper stirrer blade and in particular of the uppermost, shortened stirrer blade.

The methods and the devices are used in particular for the production of glass articles having a high small-scale and large-scale viscosity homogeneity; large stirrer vessels are particularly suitable for this purpose, because large stirrer vessels permit long residence times for the homogenization (long residence times for expansion, redistribution, reorientation, separation of in particular large-scale and small-scale composition inhomogeneities of the glass melt), the stirrer-induced corrosion of the stirrer vessel, built up from, for example, highly zirconium-containing refractory material, is minimized by low rotational speeds and therefore low wall shear stress.

The device comprising stirrer vessel and blade stirrer is preferably designed such that the following conditions are fulfilled:

high homogeneity index

$$H = N \cdot v \cdot \frac{ρ {nLD}^{2}}{\dot{m}} > 6000 ,$$

(N: number of stirrer systems; ν: rotational speed; ρ: density of the glass;

n: number of stirrer blades;

L: length of the stirrer;

D: diameter of the stirrer; and

\dot{m}: mass flow.

Minimization of the wall shear stress

$$τ = η \cdot \frac{π D}{w} \cdot v < 500 Pa$$

on the refractory material with >90% ZrO₂ (η: viscosity of the glass; D: diameter of the stirrer; w: wall spacing; ν: rotational speed).

Surface-volume ratio

$$OVR = \frac{A}{V} = \frac{3}{2} \cdot \frac{1}{L}$$

is therefore defined; this is comparatively high in comparison with other stirrer systems.

These conditions are achieved by a large stirred volume, i.e. large diameter D and overall length L and by moderate rotational speeds.

The device can preferably have a typical stirrer rotational speed of 6 rev/min. The geometry of the stirrer vessel is preferably approximately a square cylinder (D approximately equal to L).

Particularly preferably, the following features of the invention are combined: Continuous drawing-in of the surface and minimization of the slopping on the inner side of the stirrer vessel; Virtually stagnating surface (“stationary” surface) and minimization of the slopping on the inner side of the stirrer vessel.

For the solution of the object according to the invention, there are substantially two equivalent approaches: Leaving the surface of the glass melt at rest to the greatest possible extent and drawing no glass melt close to the surface into the volume or into the discharge flow.

Drawing in the surface glass melt continuously, i.e. keeping the residence time of the glass melt at the surface so low that no noticeable viscosity difference can be formed.

### BRIEF DESCRIPTION OF THE DRAWINGS

FIG. 1a shows device 1 from the side (stirrer blade position transverse);

FIG. 1b shows device 1 from the side (stirrer blade position longitudinal);

FIG. 1c shows device 1 from the side (stirrer blade position longitudinal, rhombic stirrer blade);

FIG. 1d shows device 1 from the side (stirrer blade position longitudinal, rhombic stirrer blade);

FIG. 2 shows device 1 from the side;

FIG. 3a shows device 1 from above (round cross section of the stirrer vessel, suspended block);

FIG. 3b shows device 1 from above (round cross section of the stirrer vessel, suspended block);

FIG. 3c shows device 1 from above (octagonal cross section of the stirrer vessel, suspended block);

FIG. 3d shows device 1 from above (octagonal cross section of the stirrer vessel);

FIG. 4 shows two devices 1 connected in series (side view);

FIG. 5a shows device 2 from the side (stirrer blade position transverse);

FIG. 5b shows device 2 from the side (stirrer blade position longitudinal);

FIG. 5c shows device 2 from the side (stirrer blade position longitudinal);

FIG. 5d shows device 2 from the side (stirrer blade position longitudinal); and

FIG. 6 shows device 2 (side view).

### DETAILED DESCRIPTION

The methods 1 and 2 and devices 1 and 2 according to the invention are to be explained in more detail by using the following examples.

### Device 1 and Method 1:

Continuous drawing-in of the glass surface confirmed by physical simulation, is achieved by five stirrer blades, all stirrer blades have a conveying action, the upper three stirrer blades are arranged on the stirrer shaft each offset by 10° and convey downwards, the downward conveyance is assisted by the geometry of the stirrer blades, the lower two stirrer blades convey upwards, being arranged offset by −10°, the upward conveyance is assisted by the geometry of the stirrer blades, the spacing of the stirrer blades on the stirrer shaft between the upper three downward-conveying stirrer blades is the same, the spacing of the stirrer blades on the stirrer shaft between the lower two upward-conveying stirrer blades is the same, the spacing of the stirrer blades between the upper three and the lower two stirrer blades, that is to say between the opposed conveying directions, is considerably greater (up to twice the spacing), the stirring circle diameter of the uppermost stirrer blade is shortened to about half the stirrer encircle diameter of the other stirrer blades and conveys downwards, the stirring circle diameter of the stirrer blade located underneath, likewise conveying downwards, is shortened to 70 to 95% of the maximum stirring circle diameter, the stirring circle diameter of the lowest upward-conveying stirrer blade is likewise shortened to 70 to 95% of the maximum stirring circle diameter, in order to improve the threading into the stirring circle in the case of a glass melt running in at the bottom.

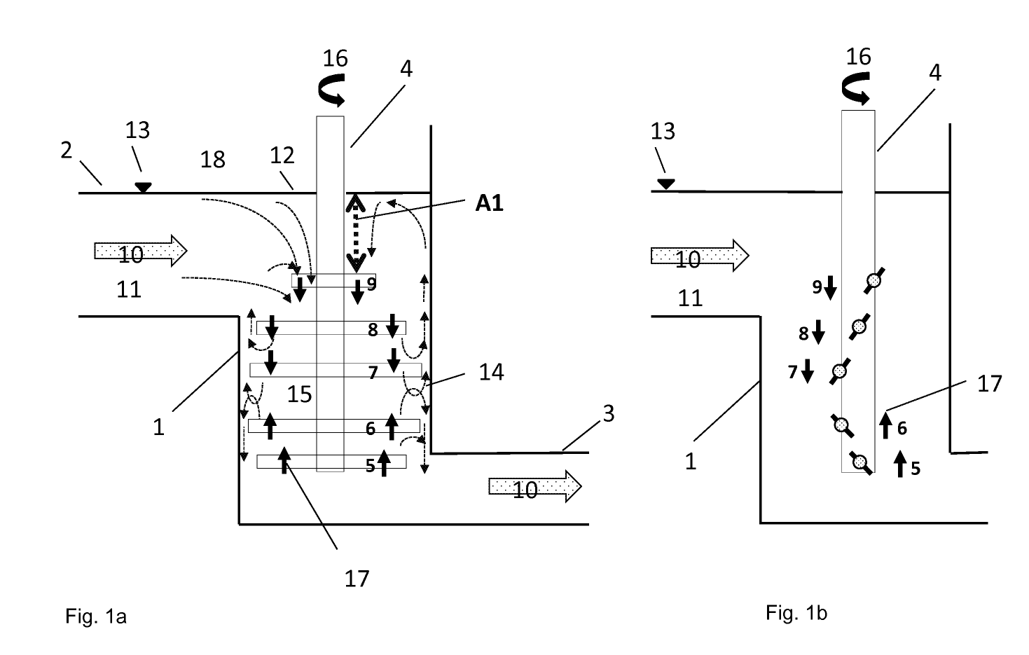

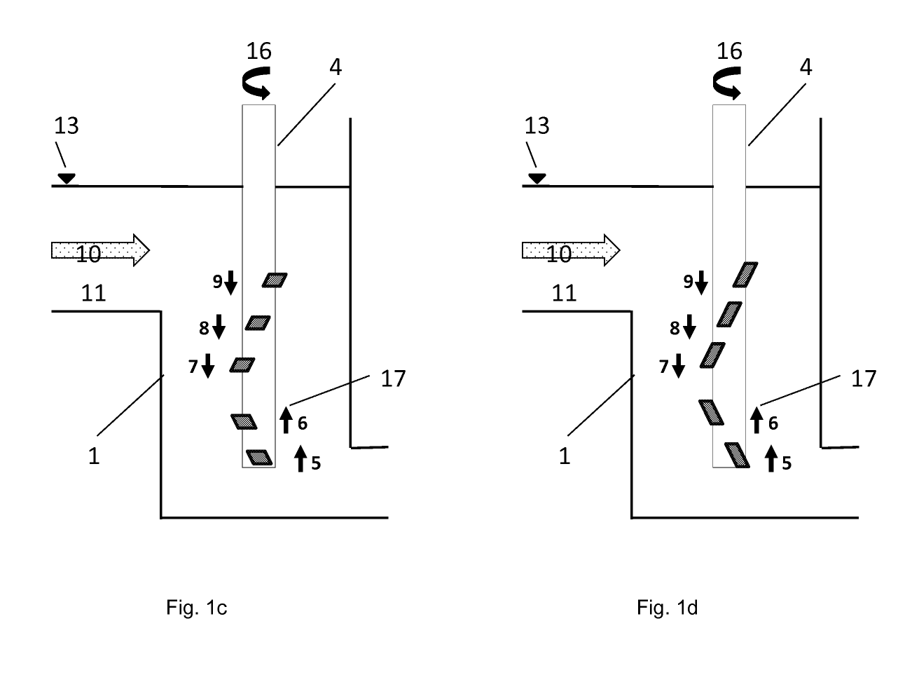

FIGS. 1a to 1d show a device 1 according to the invention for producing a glass article from a glass melt (11), comprising at least the following means: inlet (2) for the continuous introduction of the glass melt (11) into the stirrer vessel (1), means for stirring the glass melt in the stirrer vessel (1) by means of at least one blade stirrer, the blade stirrer having five stirrer blades (5, 6, 7, 8, 9), which are fixed to a stirrer shaft (4) arranged substantially vertically in the stirrer vessel (1), outlet (3) for the continuous discharge of the glass melt (11) from the stirrer vessel (1), means for shaping the glass melt, obtaining the glass article (not illustrated).

The means for stirring the glass melt are configured and arranged in such a way that the glass melt (12) which is located at the surface in the stirrer vessel (1) can be drawn into the stirrer vessel (1), so that the formation of a surface layer of the glass melt with a different composition from the composition of the glass melt (11) introduced can be prevented or at least minimized.

The uppermost stirrer blade (9) is configured in such a way and is arranged at a distance A1 from the surface (13) of the glass melt (11) in the stirrer vessel (1) such that the drawing-in action is substantially effected as a result.

To produce a glass article from a glass melt (11), the glass melt (11) is introduced continuously into a stirrer vessel (1) through an inlet (2). The stirring of the glass melt (11) in the stirrer vessel (1) is carried out by means of a blade stirrer, the blade stirrer having five stirrer blades (5, 6, 7, 8, 9), which are fixed to a stirrer shaft (4) arranged substantially vertically in the stirrer vessel (1). The glass melt (11) is discharged continuously out of the stirrer vessel (1) through the outlet (3). The shaping of the glass melt (11), obtaining the glass article, is carried out in a downstream method step, e.g. floating the glass melt or rolling or drawing the glass melt (11). By means of the stirring, the glass melt (12) which is located at the surface in the stirrer vessel (1) is drawn into the stirrer vessel (upper, dashed arrows), so that the formation of a surface layer of the glass melt with a different composition from the composition of the glass melt (11) introduced is prevented or at least minimized.

The uppermost stirrer blade (9) is configured in such a way and arranged at a distance A1 from the surface (13) of the glass melt (11) in the stirrer vessel (1) such that the drawing-in action is substantially effected as a result.

The fact that the glass melt (12) which is located at the surface in the stirrer vessel (1) is drawn into the stirrer vessel (1), in particular towards the stirrer shaft (4), means that even minimal changes in the composition of the glass melt (12) at the surface thereof are compensated for. The albeit only slightly changed surface glass melt (12) is mixed in good time with the remaining glass melt (11), so that no disruptive inhomogeneities at all can form. It depends substantially on the requirements on the glass article to be produced as to how intensely the glass melt which is located at the surface in the stirrer vessel has to be drawn into the stirrer vessel (1), in particular towards the stirrer shaft (4), by the stirring, so that the formation of a surface layer of the glass melt with a different composition from the composition of the glass melt (11) introduced is prevented (very high requirements on the optical properties of the glass article) or at least minimized (at least such that the glass article to be produced in particular satisfies the optical specifications).

As mentioned, the blade stirrer has a plurality of stirrer blades (5, 6, 7, 8, 9), the uppermost stirrer blade (9) and the following stirrer blades (7, 8) generating a downward flow of the glass melt along the stirrer shaft (4), and the lowest stirrer blade (5) and the stirrer blade (6) arranged above the latter generating an upward flow of the glass melt along the stirrer shaft (4). A smaller spacing is set between the adjacent stirrer blades (stirrer blades (7, 8, 9) and stirrer blades (5, 6)), which each generate a unidirectional flow of the glass melt (11) along the stirrer shaft (4), than between the adjacent stirrer blades (5, 6) and (7, 8, 9) that generate an opposed flow of the glass melt (11) along the stirrer shaft (4). The greater spacing between the opposed conveying directions is necessary since, as a result, space/volume is created, in order not only to expand the inhomogeneities; instead they are additionally further redistributed, reoriented, which contributes considerably to improving the homogeneity.

The conveying direction (17) of the stirrer blades (5, 6, 7, 8, 9) is illustrated by means of arrows at the stirrer blade ends. The larger spacing (15) between the stirrer blades (6, 7) is likewise shown.

The stirrer blades have a rhombic geometry (see FIG. 1b); depending on the arrangement of the rhombus, the corresponding downward and upward conveyance is therefore assisted.

The continuous introduction of the glass melt (11) is carried out in an upper region of the stirrer vessel (1), and the continuous discharge in a lower region of the stirrer vessel (1).

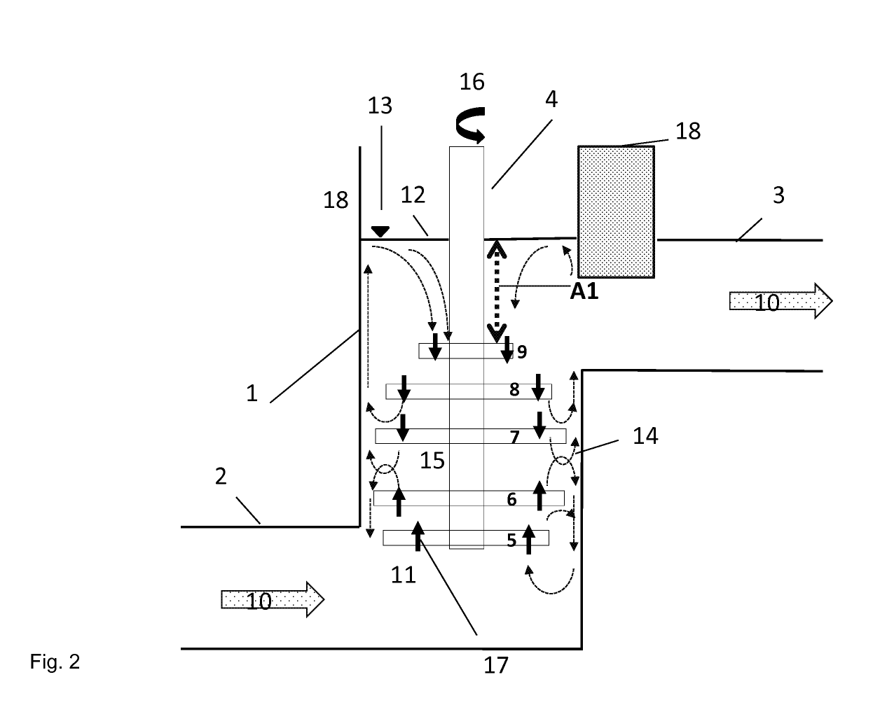

FIG. 2 shows a device 1 according to the invention wherein the inlet (2) is located in the lower region of the stirrer vessel (1) and the outlet (3) in the upper region of the stirrer vessel (1). Arranged in the outlet (3) is what is known as a suspended block (18), in order to ensure symmetrical and uniform drawing-in of the surface.

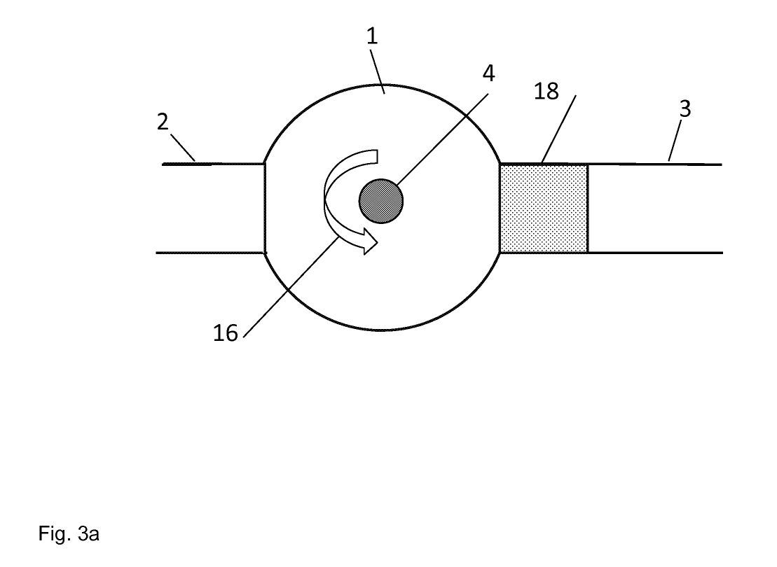

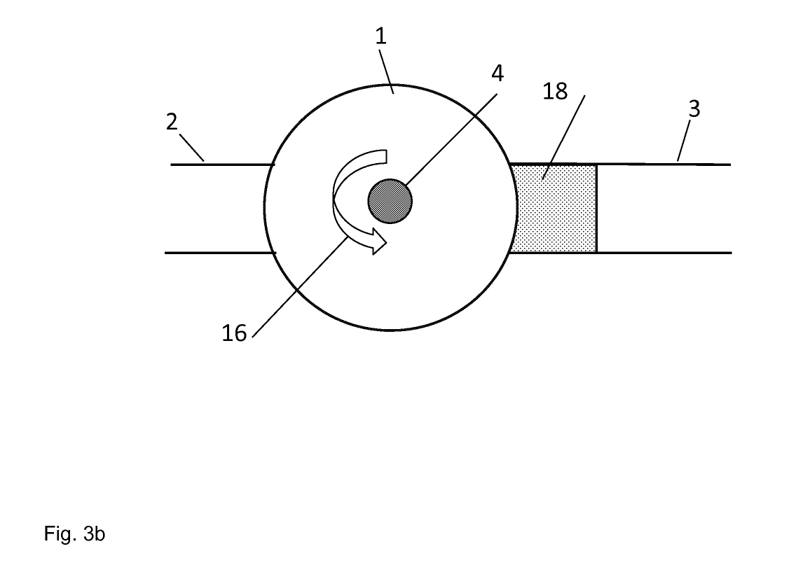

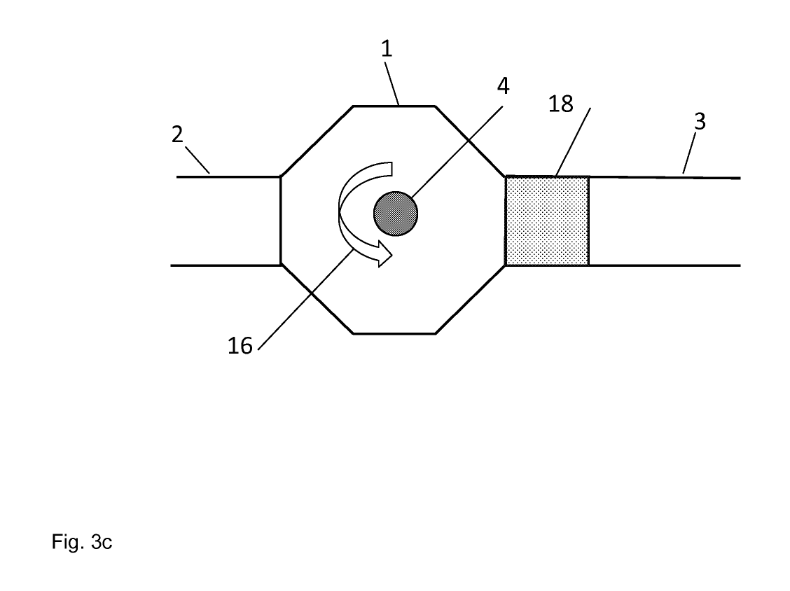

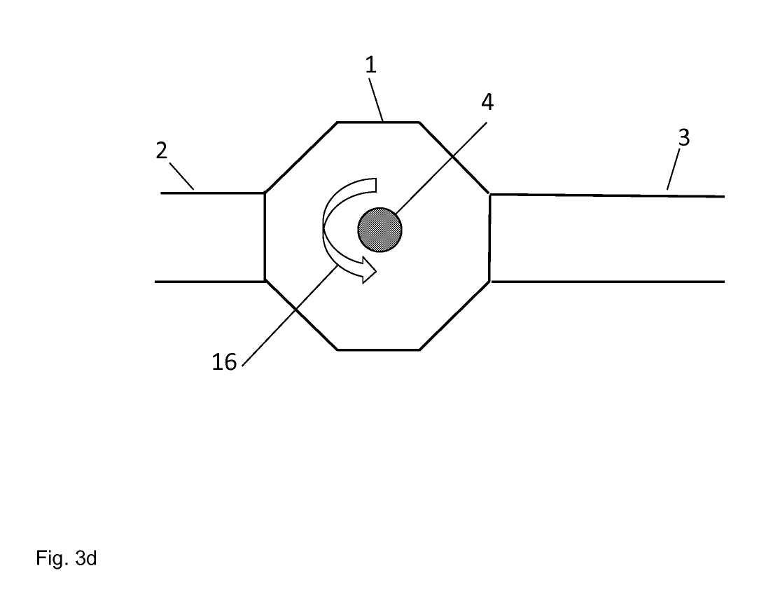

FIGS. 3a to 3d show the device 1 according to the invention from FIG. 2 from above (without showing the stirrer blades).

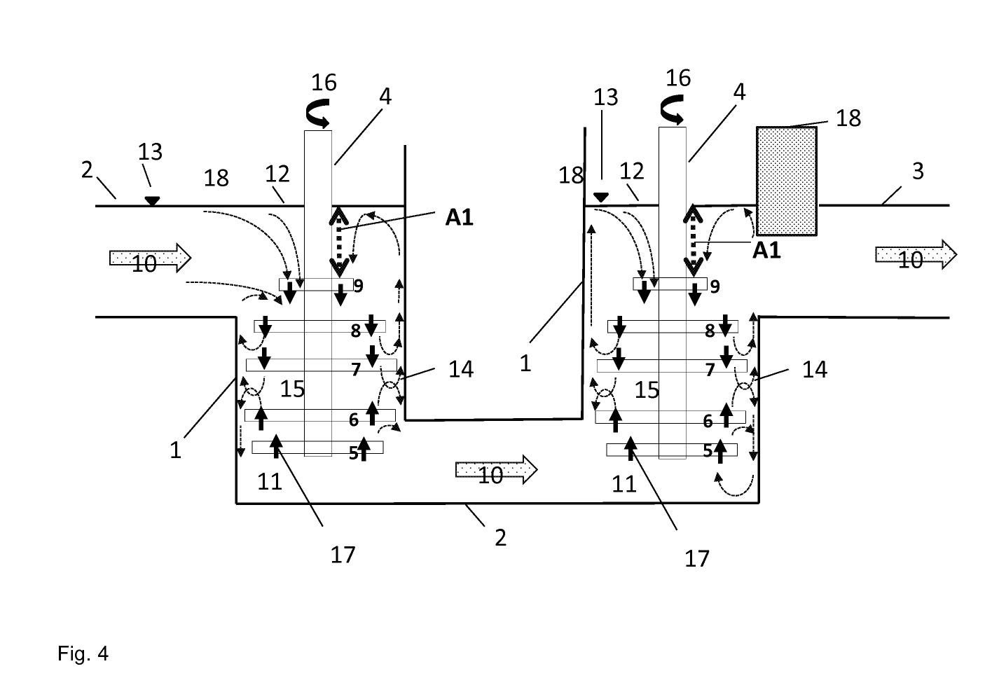

FIG. 4 shows two devices 1 according to the invention, two stirrer vessels (1) being arranged in series. As a result, the homogenizing action is improved considerably in accordance with the equation for the homogeneity index H.

### Device 2 and Method 2

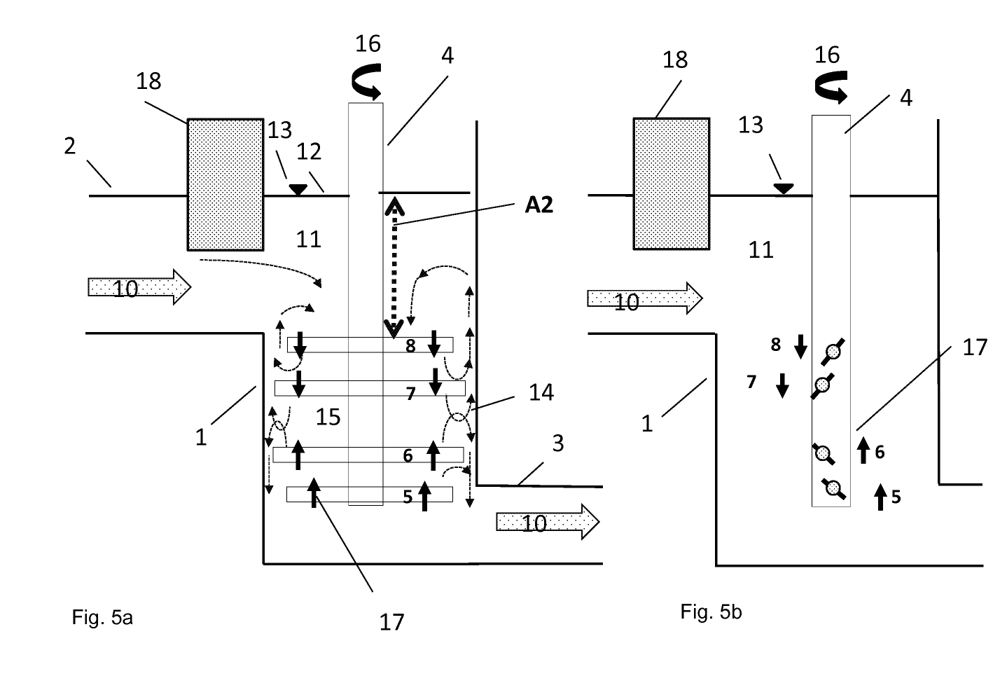

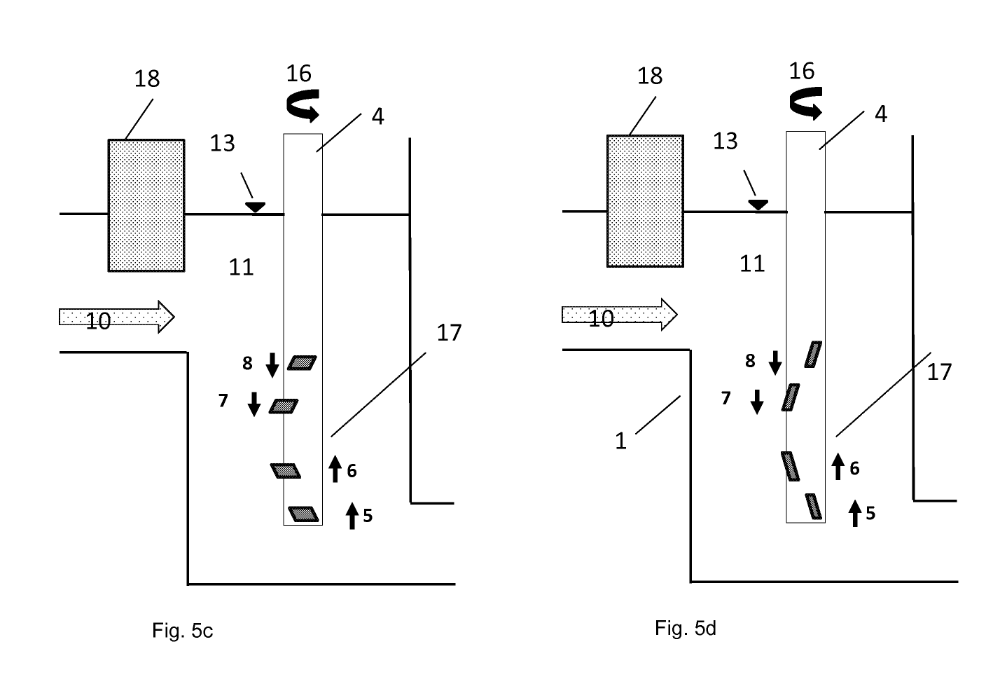

FIGS. 5a to 5d show a device 2 according to the invention for producing a glass article from a glass melt (11), comprising at least the following means: inlet for the continuous introduction of the glass melt (11) into a stirrer vessel (1), means for stirring the glass melt (11) in the stirrer vessel by means of at least one blade stirrer, the blade stirrer having four stirrer blades (5, 6, 7, 8), which are fixed to a stirrer shaft (4) arranged substantially vertically in the stirrer vessel (1),

outlet (3) for the continuous discharge of the glass melt (11) from the stirrer vessel (1),

means for shaping the glass melt, obtaining the glass article (not illustrated).

Here, the means for stirring the glass melt (11) are configured in such a way and arranged such that the glass melt (12) which is located at the surface in the stirrer vessel (1) cannot be drawn into the stirrer vessel (1) or is drawn in only insubstantially.

The uppermost stirrer blade (8) is configured in such a way and arranged at a distance A2 from the surface (13) of the glass melt (11) in the stirrer vessel (1) such that the glass melt (12) which is located at the surface in the stirrer vessel (1) is substantially not drawn into the stirrer vessel (1) or is drawn in only insubstantially as a result.

To produce a glass article from a glass melt (11), the glass melt (11) is introduced continuously into a stirrer vessel (1) through an inlet (2). The stirring of the glass melt (11) in the stirrer vessel (1) is carried out by means of a blade stirrer, the blade stirrer having four stirrer blades (5, 6, 7, 8), which are fixed to a stirrer shaft (4) arranged substantially vertically in the stirrer vessel (1). The glass melt (11) is led continuously out of the stirrer vessel (1) through the outlet (3). The shaping of the glass melt (11), obtaining the glass article, is carried out in a downstream method step, e.g. floating the glass melt (11) or rolling or drawing the glass melt (11). As a result of the stirring, the glass melt (11) which is located at the surface (12) in the stirrer vessel (1) is not drawn into the stirrer vessel or is drawn in only insubstantially.

The fact that the glass melt (12) which is located at the surface in the stirrer vessel (1) is not drawn into the stirrer vessel (1) or is drawn in only insubstantially means that a protective layer with a different composition from the composition of the glass melt (11) introduced can form at the surface of the glass melt in the stirrer vessel (1), which effectively prevents a further change in the composition of the glass melt (11) in the stirrer vessel (1), so that no disruptive inhomogeneities can form at all. It depends substantially on the glass article to be produced as to how the glass melt (12) which is located at the surface in the stirrer vessel (1) is not drawn into the stirrer vessel (1) (very high requirements on the optical properties of the glass article) or is drawn in only insubtantially (at least such that the glass article to be produced in particular satisfies the optical specifications) by the stirring.

The uppermost stirrer blade (8) is configured in such a way and arranged at a distance A2 (A2>A1) from the surface (13) of the glass melt in the stirrer vessel such that the glass melt (12) which is located at the surface in the stirrer vessel (1) is substantially not drawn into the stirrer vessel (1) or is drawn in only insubstantially as a result.

As mentioned, the blade stirrer has a plurality of stirrer blades (5, 6, 7, 8), the uppermost stirrer blade (8) and the following stirrer blade (7) lying below the latter generating a downward flow of the glass melt (11) along the stirrer shaft (4), and the lowest stirrer blade (5) and the stirrer blade (6) arranged above the latter generating an upward flow of the glass melt (11) along the stirrer shaft (4). A smaller spacing is set between the adjacent stirrer blades (7, 8) and stirrer blades (5, 6), which each generate a unidirectional flow of the glass melt (11) along the stirrer shaft, than between the adjacent stirrer blades (6, 7) that generate an opposed flow of the glass melt along the stirrer shaft (4).

Here, the continuous introduction of the glass melt (11) is carried out in the upper region of the stirrer vessel (1), and the continuous discharge in the lower region of the stirrer vessel (1).

A plurality of stirrer vessels (1) can be arranged in series.

In addition, what is known as a suspended block (18) is arranged in the inlet (2), in order to keep contaminants, inhomogeneities which are located at the surface of the glass melt (11) to be introduced away from the stirrer vessel (1). Method 2 and device 2 are also possible without a suspended block, depending on the requirements on homogeneity, high homogeneity requires a suspended block in the inlet and/or outlet.

As a result of the stirring, the glass melt (12) which is located at the surface in the stirrer vessel can effect a maximum amplitude of the up-and-down movement of the glass melt at the surface of at most 2%, preferably at most 1%, of the glass melt level in the stirrer vessel at a stirrer rotational speed of 6 rev/min.

The stirrer blades have a rhombic geometry (see FIGS. 5c and 5d); depending on the arrangement of the rhombus, the corresponding downward and upward conveyance is therefore assisted.

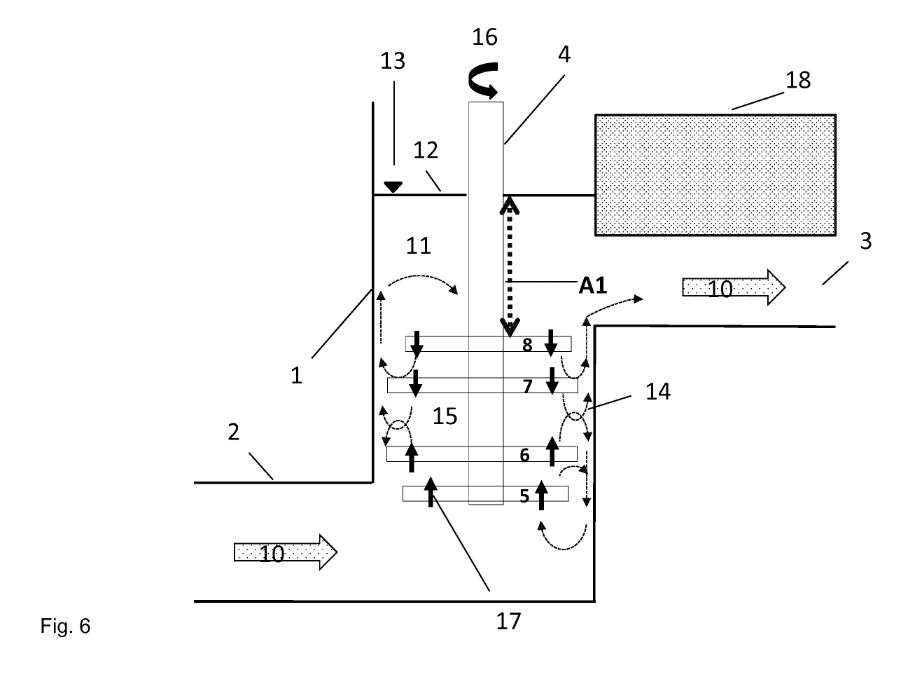

FIG. 6 shows a device 2 according to the invention, the inlet (2) being arranged in the lower region of the stirrer vessel (1) and the outlet (3) in the upper region of the stirrer vessel (1).

Further design variants: Device for producing a glass article, wherein: the wall shear stress is less than 500 Pa, the slopping movement of the glass melt surface is less than 20 mm, preferably less than 10 mm, the blade stirrer consists of noble metal or of a noble metal clad core, the glass melt is led out into a covered or uncovered stone channel and/or noble metal channel.

Further design variants: Method for producing a glass article, wherein: flat glass and substrate glass for electronic applications, preferably for flat displays, is produced, the strip-like vertical fluctuations of the glass surface, designated waviness (r.m.s. value of the surface profile for structure widths between 0.8 mm and 8 mm; cf. SEMI D24-2000; Specification for glass substrates used to manufacture flat panel displays 2006), being less than 200 nm, preferably less than 100 nm, further preferably less than 70 nm.

### LIST OF REFERENCE SYMBOLS

1 Stirrer vessel
2 Inlet (or passage in a double stirring device)
3 Outlet
4 Stirrer shaft
5 Stirrer blade conveying upwards
6 Stirrer blade conveying upwards
7 Stirrer blade conveying downwards
8 Stirrer blade conveying downwards
9 Stirrer blade conveying downwards
10 Throughput flow of the glass melt
11 Glass melt
12 Glass melt at the surface in the stirrer vessel
13 Glass melt level
14 Edge gap flow and flows of the glass melt as a result of stirrer movement (dashed arrows)
15 Spacing between the stirrer blades with opposed conveying action
16 Direction of rotation of the stirrer
17 Conveying direction of the stirrer blades (arrows at the tips of the stirrer blades)
18 Suspended block
A1/A2 Distance from glass melt level as far as the top edge of the uppermost stirrer blade

What is claimed is:

1. A method for producing a glass article from a glass melt, comprising:
continuously introducing the glass melt into a stirrer vessel,
stirring the glass melt in the stirrer vessel by at least one blade stirrer, the at least one blade stirrer having at least one stirrer blade which is fixed to a stirrer shaft arranged substantially vertically in the stirrer vessel,
continuously discharging the glass melt from the stirrer vessel, and
shaping the glass melt to obtain the glass article.

2. The method according to claim 1, wherein the stirring is sufficient to draw the glass melt located at a surface of the stirrer vessel into the stirrer vessel so that a formation of a surface layer of the glass melt with a different composition from the composition of the glass melt introduced is prevented or at least minimized.

3. The method according to claim 2, wherein the at least one blade stirrer comprises an uppermost stirrer blade configured and arranged at a distance A1 from a surface of the glass melt in the stirrer vessel such that the drawing-in action is substantially effected as a result.

4. The method according to claim 1, wherein the stirring is sufficient so that the glass melt which is located at a surface in the stirrer vessel is not drawn into the stirrer vessel or is drawn in only insubstantially.

5. The method according to claim 4, wherein the at least one blade stirrer comprises an uppermost stirrer blade configured and arranged at a distance A2 from the surface of the glass melt in the stirrer vessel such that the glass melt which is located at the surface in the stirrer vessel is substantially not drawn into the stirrer vessel or is drawn in only insubstantially as a result.

6. The method according to claim 1, wherein the at least one blade stirrer has a plurality of stirrer blades, an uppermost stirrer blade generating a downward flow of the glass melt along the stirrer shaft and a lowest stirrer blade generating an upward flow of the glass melt along the stirrer shaft.

7. The method according to claim 1, wherein the blade stirrer has a plurality of stirrer blades, a smaller spacing being set between adjacent stirrer blades which generate a unidirectional flow of the glass melt along the stirrer shaft than between adjacent stirrer blades which generate an opposed flow of the glass melt along the stirrer shaft.

8. The method according to claim 1, wherein the step of continuously introducing the glass melt into the stirrer vessel comprises continuously introducing the glass melt to an upper region of the stirrer vessel and wherein the step of continuously discharging the glass melt from the stirrer vessel comprises continuously discharging the glass melt from a lower region of the stirrer vessel.

9. The method according to claim 1, wherein the step of continuously introducing the glass melt into the stirrer vessel comprises continuously introducing the glass melt to a lower region of the stirrer vessel and wherein the step of continuously discharging the glass melt from the stirrer vessel comprises continuously discharging the glass melt from an upper region of the stirrer vessel.

10. The method according to claim 1, further comprising arranging a plurality of stirrer vessels in series to stir the glass melt.

11. The method according to claim 1, wherein, as a result of the stirring, the glass melt located at a surface at a surface of the stirrer vessel effects a maximum amplitude of up-and-down movement of at most 2% of a glass melt level in the stirrer vessel at a stirrer rotational speed of 6 rev/min.

12. The method according to claim 1, wherein the at least one stirrer has rotational speed set in the range from 0.5 to 20 rev/min.

13. The method according to claim 1, wherein the step of shaping the glass melt comprises a process selected from the group consisting of floating, rolling, and drawing.

14. A device for producing a glass article from a glass melt, comprising:
a continuous glass introduction device to continuously introduce the glass melt into a stirrer vessel,
a glass stirring device having at least one blade stirrer in the stirrer vessel, the at least one blade stirrer having at least one stirrer blade fixed to a stirrer shaft arranged substantially vertically in the stirrer vessel,
a continuous glass discharge to continuously discharge the glass melt from the stirrer vessel, and
a glass shaping device configured to shape the glass melt into the glass article.

15. The device of claim 14, wherein glass stirring device is sufficient to draw in the glass melt which is located at a surface in the stirrer vessel into the stirrer vessel so that the formation of a surface layer of the glass melt with a different composition from the composition of the glass melt introduced can be prevented or at least minimized.

16. The device according to claim 15, wherein the at least one blade stirrer comprises an uppermost stirrer blade configured and arranged at a distance A1 from the surface of the glass melt in the stirrer vessel such that the drawing-in action is substantially effected as a result.

17. The device according to claim 14, wherein glass stirring device is sufficient so that the glass melt which is located at a surface in the stirrer vessel is not drawn into the stirrer vessel or is drawn in only insubstantially.

18. The device according to claim 17, wherein the at least one blade stirrer comprises an uppermost stirrer blade configured and arranged at a distance A2 from the surface of the glass melt in the stirrer vessel such that the glass melt which is located at the surface in the stirrer vessel is substantially not drawn into the stirrer vessel or is drawn in only insubstantially as a result.
